(19) United States
(12) Patent Application Publication
(10) Pub. No.: US 2026/0236285 A1
(43) Pub. Date: Aug. 13, 2026

(54) METHOD AND COMPUTING SYSTEM FOR PROVIDING PROTECTED EXECUTION ENVIRONMENT

(71) Applicant: Samsung Electronics Co., Ltd., Suwon-si (KR)

(72) Inventors: Won Gun LEE, Suwon-si (KR); Si-Heung Kim, Suwon-si (KR); Joon Hong Park, Suwon-si (KR); Ji Hoon Lee, Suwon-si (KR); Ju Hyeon Jang, Suwon-si (KR)

(73) Assignee: SAMSUNG ELECTRONICS CO., LTD., Suwon-si (KR)

(21) Appl. No.: 19/303,879

(22) Filed: Aug. 19, 2025

(30) Foreign Application Priority Data
Feb. 7, 2025 (KR) 10-2025-0016015

(51) Int. Cl. G06F 9/455; G06F 21/53

(52) U.S. Cl. CPC G06F 9/45558; G06F 21/53; G06F 2009/45587; G06F 2221/033

(57) ABSTRACT

A method for providing a protected execution environment performed by a computing device is provided. The method includes booting a hypervisor (e.g., type-1 hypervisor) installed on the computing device in response to power-on of the computing device; provisioning a first virtual machine that provides the non-trusted execution environment and a second virtual machine that provides the protected execution environment, by using the hypervisor; and executing a second virtual CPU of the second virtual machine by using virtual CPU preemption and pausing execution of a first virtual CPU of the first virtual machine based on a request for a first protected service during execution of a first application, the first application being executed on a general guest operating system of the first virtual machine. The method may also include returning a physical CPU allocated to the second virtual CPU subsequent to completing the first protected service.

### CROSS-REFERENCE TO RELATED APPLICATION

This application claims priority from Korean Patent Application No. 10-2025-0016015 filed on Feb. 7, 2025, in the Korean Intellectual Property Office and all the benefits accruing therefrom under 35 U.S.C. 119, the contents of which in its entirety are herein incorporated by reference.

### BACKGROUND

The present disclosure relates to a method for providing a protected execution environment and a computing device thereof, and more particularly, to a method for providing a protected execution environment that supports an intermediate security level between a non-trusted execution environment and a trusted execution environment.

A security architecture of a System On Chip (SoC), such as ARM's TrustZone Media Protection (TZMP) architecture, is provided for security computation and to prevent leakage of sensitive data. TZMP technology has advanced from the existing TZMP 1.0 to TZMP 2.0 technology announced in 2017 by introducing virtualization technology. The TZMP technology can provide strong security functions by isolating hardware resources such as a Central Processing Unit (CPU) and an address space of a memory between a non-security region and a security region.

The TZMP 1.0 architecture supports two execution environments, a non-trusted execution environment and a trusted execution environment. In the TZMP 1.0 architecture, the trusted execution environment, where sensitive data and security functions are processed and stored, is isolated from the non-trusted execution environment, and switching between the trusted execution environment and the non-trusted execution environment is performed only through a secure monitor. IN TZMP 1.0 architecture, when the trusted execution environment is executed, no interruption occurs in the non-trusted execution environment. Therefore, an application executed in the non-trusted execution environment cannot maliciously interfere with execution of an application executed in the trusted execution environment until the trusted execution environment terminates execution by itself and the secure monitor switches to the non-trusted execution environment.

In addition, all communication between the non-trusted execution environment and the trusted execution environment can be performed only through the GlobalPlatform API. In other words, communication between the non-trusted execution environment and the trusted execution environment can be performed only through the verified standard API. In order for an application executed in the non-trusted execution environment to send a message to an application executed in the trusted execution environment through the GlobalPlatform API, Universally Unique Identifier (UUID) of the application executed in the trusted execution environment should be known. In this way, the TZMP 1.0 architecture blocks the possibility of sensitive data protected in the trusted execution environment being leaked during a communication process between the non-trusted execution environment and the trusted execution environment.

However, the trusted execution environment of the TZMP 1.0 architecture, while providing string security, is an expensive resource. That is, since the trusted execution environment of the TZMP 1.0 architecture is hardware-isolated from the non-trusted execution environment, hardware resources partitioned into the trusted execution environment cannot be utilized at all by the non-trusted execution environment. Therefore, commercial applications or commercial services that can be executed through the trusted execution environment of the TZMP 1.0 architecture are limited to computations that require a high level of security for processing sensitive data.

To overcome such limitations of the TZMP 1.0 architecture, the TZMP 2.0 architecture was released. The TZMP 2.0 architecture provides a protected execution environment that provides an intermediate level of security between the non-trusted execution environment and the trusted execution environment by utilizing virtualization technology. The protected execution environment can be mainly suitable for intermediate security tasks such as payment, DRM, and face recognition.

In the TZMP 2.0 architecture, the non-trusted execution environment is referred to as a non-trusted world, and the trusted execution environment is referred to as a trusted world. Hereinafter, in the present disclosure, it is noted that the terms non-trusted execution environment as a concept corresponding to the non-trusted world, trusted execution environment as a concept corresponding to the trusted world, and protected execution environment as a concept corresponding to the protected world may be used together.

Hereinafter, an operation in which a user application executed in the non-trusted world utilizes a protected service executed in the protected world based on the TZMP 2.0 architecture will be described with reference to FIGS. 1 and 2. For example, the user application may be an social media app that provides a user authentication function based on face recognition, and the protected service may be a user authentication-related service through face recognition technology.

FIG. 1 is a schematic diagram illustrating a TZMP 2.0 based System on Chip (SoC) architecture according to the related art based on layers. The SoC designed based on the TZMP 2.0 based SoC architecture includes an operating system layer (OS layer), a virtualization privilege layer 20, a security privilege layer 30, and hardware 40. Detailed functions and configurations of each layer will be understood with reference to the TZMP 2.0 based SoC architecture by a person of skill in the art.

The isolation of a non-trusted execution environment 10, a trusted execution environment 12 and a protected execution environment 11 of the SoC from one another to provide security will be described based on the protected execution environment 11. Since the non-trusted execution environment 10, the trusted execution environment 12, and the protected execution environment 11 are isolated execution environments, individual operating systems 10-1, 11-1 and 12-1 are installed in the non-trusted execution environment 10, the trusted execution environment 12, and the protected execution environment 11, respectively. For example, a guest operating system 10-1 may be installed on a first virtual machine (VM #1) 22 that provides the non-trusted execution environment 10, a protected guest operating system 11-1 may be installed on a second protected virtual machine (pVM #2) 23 that provides the protected execution environment 11, and a secure guest operating system 12-1 may be installed in the trusted execution environment 12.

The user application executed in the non-trusted execution environment 10 may transmit a protected requirement requesting a protected service executed in the protected execution environment 11 to the protected service through an inter-VM communication method supported by a hypervisor 21. In addition, the protected service executed in the protected execution environment 11 may transmit a protected requirement requesting a secure service executed in the trusted execution environment 12 to the secure service through a GlobalPlatform API. The GlobalPlatform API is an example of communication between a non-trusted execution environment and a trusted execution environment, which are supported by a secure monitor 31.

The non-trusted execution environment 10 of the SoC is executed through the VM #1 22, and the protected execution environment 11 is executed through the pVM #2 23. The hypervisor 21 installed in the virtualization privilege layer 20 virtualizes various physical resources 41 and 43 of the hardware 40 and allocates the virtualized resources to provisioned first and second virtual machines 22 and 23.

Each of the VM #1 22 and the pVM #2 23 may have a unique identifier. The identifier of the virtual machine may be indicated as a Virtual Machine Identifier (VMID) in this specification or drawing. Each of the VM #1 22 and the pVM #2 23 may be hardware-isolated from each other. For example, a virtual CPU (vCPU) allocated to the VM #1 22 may be hardware-access controlled so as not to access an address space of a memory 43 allocated to the pVM #2 23.

The above access control may be performed by controlling master-based filters 42-1 and 42-3 by a Protected Media Management (PMM) 24 that is a module of the hypervisor 21. For example, the PMM 24 may control the master-based filter 42-1 connected to the CPU 41 to prevent a memory access transaction created by a virtual CPU allocated to the VM #1 22 at the request of the user application executed in the non-trusted execution environment 10 from accessing the address space allocated to the pVM #2 23 of the physical memory 43. In addition, the PMM 24 may control the master-based filter 42-3 connected to an Intellectual Property (IP) 42-2 so that a memory access transaction of a Direct Memory Access (DMA) method created by the IP 42-2 at the request of the application executed in the non-trusted world cannot access the address space allocated to the pVM #2 23 of the memory 43.

One protected execution environment 11 may provide one protected service. Therefore, the hypervisor 21 installed in the SoC may provision multiple virtual machines to provide a plurality of protected services. The TZMP 2.0 based SoC architecture activates a virtual machine only while the protected service is being executed, for efficient use of hardware resources, and removes the virtual machine created for the execution of the protected service when the execution of the protected service is terminated. Accordingly, when a response time for a request for the protected service becomes so long that commercialization is impossible, or when the amount of available hardware resources included in the SoC is insufficient to the extent that provisioning of the virtual machine for the protected service is impossible, a protected service fail may occur.

A method for providing a protected execution environment based on a TZMP 2.0 architecture will be described with reference to FIG. 2.

When the SoC is powered on (S1), a host operating system and a hypervisor of the non-trusted execution environment are booted (S2), and applications installed in the host operating system or one or more guest operating systems may be executed in accordance with a user's manipulation (S3).

When a specific application among the executed applications requests a protected service (S4), the hypervisor prepares to create a protected virtual machine pVM (S5). The protected virtual machine may be understood as the pVM #2 23 described with reference to FIG. 1 as a virtual machine for providing a protected execution environment.

When the hypervisor may fail to create the protected virtual machine pVM due to insufficient remaining hardware resources of the SoC, such as a memory (S6). When resource acquisition for the creation of the protected virtual machine pVM fails (S6), the hypervisor may reattempt to acquire resources for the creation of the protected virtual machine pVM after a preset sleep time. When the creation of the protected virtual machine pVM continues to fail despite performing the reattempts a number of times exceeding a reference value, the hypervisor may reply to the application that the protected service execution has failed (S12).

When the resource acquisition for the creation of the protected virtual machine pVM succeeds (S6), the hypervisor may create a virtual CPU (vCPU) thread for the creation of a vCPU to be allocated to the protected virtual machine pVM on the host operating system (S7), and may create the protected virtual machine pVM (S8).

A scheduler of the host operating system may perform scheduling for the vCPU thread while performing scheduling logic under the control of the hypervisor (S9). When the host operating system is in a busy state, the vCPU thread will not be scheduled for execution, and the host operating system may reattempt scheduling for the vCPU thread. That is, when the host operating system is in a busy state, the resource for the virtual CPU of the protected virtual machine pVM will not be allocated, and as a result, the response time for the protected service will be delayed. In embodiments, when the host operating system continues to fail to schedule the vCPU thread, the SoC will reply to the application that the protected service execution has failed (S12).

When the host operating system succeeds in scheduling for the vCPU thread, the protected guest operating system is booted on the protected virtual machine pVM (S14). After the booting of the protected guest operating system is completed, the protected service is created (S15), and the hypervisor reads a request for the protected service from the application installed on the host operating system or the guest operating system (S16). Next, the protected service is executed (S17) e.g., by the protected virtual machine pVM, and the hypervisor will transmit the execution result of the protected service to the application, which is the requester (S18).

At this time, the hypervisor may remove the protected virtual machine pVM (S10), to prevent the virtual machine pVM that has completed the execution of the protected service from continuously occupying the physical hardware resources of the SoC. Accordingly, the protected guest operating system will be naturally terminated (S19).

As the execution result of the protected service is delivered to the application, context switching to the application will be performed, and the operation of the application requesting the protected service and receiving the result will be completed (S13).

The TZMP 2.0 based SoC architecture described with reference to FIG. 2 adopts the hardware resources of the host operating system to drive the protected execution environment in which the protected service is executed.

Accordingly, the free memory required for creating the protected virtual machine pVM on the host operating system may be insufficient. Furthermore, when the CPU of the host operating system is in a busy state, the vCPU thread for the virtual CPU (vCPU) of the protected virtual machine pVM may not be scheduled for a long period of time. This may result in a delay in the response time of the protected service for the application or the possibility of service failure.

In addition, the protected virtual machine pVM for executing the protected service is created and the booting of the protected guest operating system is performed only at the time when the application requests the protected service. That is, a time delay based on the amount of time required for the creation of the virtual machine and the booting of the protected guest operating system cannot be avoided.

In summary, the protected execution environment implementation method based on the TZMP 2.0 based SoC architecture has a problem in that the protected service executed in the protected world does not make sure of the preset response time. The service of the protected world, which does not make sure of the preset response time, will make it difficult to apply to real-time systems such as autonomous vehicles and user authentication devices.

### SUMMARY

An embodiment of the present disclosure provides a method for providing a service in a protected world based on virtualization of TZMP technology, in which the possibility of response time delay is minimized, and a computing device to which the method is applied.

Another embodiment of the present disclosure provides a method for providing a service in a protected world based on virtualization of TZMP technology without service failure and a computing device to which the method is applied.

Another embodiment of the present disclosure provides a method for providing a service in a protected world of TZMP technology and a computing device to which the method is applied, which improves efficiency of resource utilization by allowing a non-trusted world to use a physical CPU allocated to a virtual CPU (vCPU) of a protected virtual machine when a protected service of the protected virtual machine is not executed while always activating the protected virtual machine to minimize the possibility of response time delay.

Another embodiment of the present disclosure provides a method for hardware-based access control so that a CPU or a Direct Memory Access (DMA) Master IP may access only a memory address space of a protected service, which is related to provision of the protected service in a protected world of TZMP technology, and a computing device to which the method is applied.

The embodiments of the present disclosure are not limited to those mentioned above and additional objects of the present disclosure, which are not mentioned herein, will be clearly understood by those skilled in the art from the following description of the present disclosure.

According to an aspect of an example embodiment of the disclosure, a method for providing a protected execution environment performed by a computing device may be provided. The computing device may support a non-trusted execution environment, the protected execution environment, and a trusted execution environment, and wherein the non-trusted execution environment and the protected execution environment operate within a central processing unit (CPU) in a first state, and the trusted execution environment operates within a CPU in a second state, which is separate from the first state. The method may include booting a hypervisor installed on the computing device in response to power-on of the computing device; provisioning a first virtual machine that provides the non-trusted execution environment and a second virtual machine that provides the protected execution environment, by using the hypervisor; executing a second virtual CPU of the second virtual machine by using virtual CPU preemption and pausing execution of a first virtual CPU of the first virtual machine based on a request for a first protected service during execution of a first application, the first application being executed on a general guest operating system of the first virtual machine; executing the first protected service on a protected guest operating system of the second virtual machine; providing a result of the first protected service to the first application; and returning a physical CPU allocated to the second virtual CPU of the second virtual machine subsequent to completing the first protected service, the physical CPU being from among one or more Physical CPUs of the computing device, where the hypervisor in the computing device is a type-1 hypervisor installed directly in the computing device without an operating system.

According to other aspect of an example embodiment of the disclosure, method for controlling access to a memory address space of a DMA master IP, performed by a computing device is provided. The computing device may support a non-trusted execution environment, a trusted execution environment, and a protected execution environment. The non-trusted execution environment and the protected execution environment may operate within a central processing unit (CPU) in a first state, and the trusted execution environment operates within a CPU in a second state, which is separate from the first state. The method may include booting a hypervisor installed in the computing device in response to power-on of the computing device; provisioning a first virtual machine that provides the non-trusted execution environment and a second virtual machine that provides the protected execution environment, by using the hypervisor; executing a first protected service as a first instance and executing a second protected service, distinct from the first protected service, as a second instance, by a protected guest operating system of the second virtual machine; and performing memory access control of a memory access transaction output from the DMA master IP, the memory access control being performed through a memory management unit of a first stage and a memory management unit of a second stage, the memory management unit of the second stage comprising a memory table for each virtual machine identifier (VMID), where the performing memory access control includes: specifying an accessible address space of the memory access transaction among memory areas of the second virtual machine by the memory management unit of the first stage based on at least one of a port, a stream ID or an address space identifier (ASID) of the memory access transaction, and where the hypervisor in the computing device is a type-1 hypervisor installed directly in the computing device without an operating system.

According to another aspect of an example embodiment of the disclosure, a method for controlling access to a memory address space of a DMA master IP, performed by a computing device that supports a non-trusted execution environment, a trusted execution environment and a protected execution environment is provided. The non-trusted execution environment and the protected execution environment operate within a central processing unit (CPU) in a first state, and wherein the trusted execution environment operates within a CPU in a second state, which is separate from the first state. The method includes booting a hypervisor installed in the computing device in response to power-on of the computing device; provisioning a first virtual machine that provides the non-trusted execution environment and a second virtual machine that provides the protected execution environment, by using the hypervisor; executing a first protected service as a first instance and executing a second protected service, distinct from the first protected service, as a second instance, by a protected guest operating system of the second virtual machine; assigning a virtual machine identifier (VMID) of a protected partition virtual machine (ppVM) for the second protected service by the hypervisor; providing a virtual machine ID (VMID) tag driver of the hypervisor with a VMID tag request for DMA IP by the second protected service, the VMID tag request being for tagging the VMID of the ppVM; and performing memory access control to an address space of the second protected service for a memory access transaction output from the DMA master IP through a memory management unit having a memory table for each VMID, where the hypervisor in the computing device is a type-1 hypervisor installed directly in the computing device without an operating system.

### BRIEF DESCRIPTION OF DRAWINGS

The above and other aspects and features of the present disclosure will become more apparent by describing in detail exemplary embodiments thereof with reference to the attached drawings, in which:

FIG. 1 is a schematic diagram illustrating an architecture for providing a TZMP2-based protected execution environment according to the related art;

FIG. 2 is a flow chart of a method for providing a protected service executed in a TZMP2-based protected execution environment according to the related art;

FIG. 3 is a diagram illustrating an exemplary SoC designed in accordance with an architecture for providing a TZMP2-based protected execution environment provided in an embodiment of the present disclosure;

FIG. 4 is a diagram illustrating a mode switching process of a physical CPU of a SoC having an architecture for providing a TZMP2-based protected execution environment provided in an embodiment of the present disclosure;

FIG. 5 is a flowchart of a method for providing a protected service executed in a TZMP2-based protected execution environment according to an embodiment of the present disclosure;

FIG. 6 is a diagram illustrating an example of performing hardware level memory access control for a CPU in an exemplary SoC designed in accordance with an architecture for providing a TZMP2-based protected execution environment provided in an embodiment of the present disclosure;

FIG. 7 is a diagram illustrating an example of hardware level access control performed so that a DMA master IP may accurately access an address space of a memory of a protected service in an exemplary SoC designed in accordance with an architecture for providing a TZMP2-based protected execution environment provided in an embodiment of the present disclosure;

FIGS. 8 to 9 are diagrams illustrating a protected partition virtual machine ppVM referenced in an embodiment of the present disclosure;

FIG. 10 is a diagram illustrating an example of hardware level access control performed so that a DMA master IP may accurately access an address space of a memory of a protected service in an exemplary SoC designed in accordance with an architecture for providing a TZMP2-based protected execution environment provided in an embodiment of the present disclosure;

FIG. 11 is a first flow chart of a method for controlling access so that a DMA master IP may accurately access an address space of a memory of a protected service in a TZMP2-based protected execution environment according to an embodiment of the present disclosure;

FIG. 12 is a diagram illustrating an example of hardware level access control performed so that a DMA master IP may accurately access an address space of a memory of a protected service in an exemplary SoC designed in accordance with an architecture for providing a TZMP2-based protected execution environment provided in an embodiment of the present disclosure;

FIG. 13 is a flow chart of a method for controlling access so that a DMA master IP may accurately access an address space of a memory of a protected service in a TZMP2-based protected execution environment according to an embodiment of the present disclosure; and

FIG. 14 is a diagram illustrating an example of hardware level access control performed so that a DMA master IP may accurately access an address space of a memory of a protected service in an exemplary SoC designed in accordance with an architecture for providing a TZMP2-based protected execution environment provided in an embodiment of the present disclosure.

### DETAILED DESCRIPTION

Hereinafter, example embodiments of the disclosure will be described with reference to the attached drawings. The advantages and features of the disclosure and methods of accomplishing the same would be understood more readily by reference to the following detailed description of example embodiments and the accompanying drawings. The disclosure may, however, be embodied in many different forms and should not be construed as being limited to the example embodiments set forth herein. Rather, these embodiments are provided so that this disclosure will be thorough and complete and will fully convey the concept of the disclosure to those skilled in the art, and the disclosure will be defined by the appended claims and their equivalents. In describing the disclosure, if it is determined that a detailed description of a related known configuration or function may obscure the gist of the disclosure, the detailed description will be omitted.

The singular expressions used in the following embodiments include plural concepts, unless the context clearly specifies singularity. Additionally, plural expressions include singular concepts, unless the context clearly specifies plurality. In addition, terms such as first, second, A, B, (a), (b) used in the following embodiments are only used to distinguish one element from another element, and the terms do not limit the nature, sequence, or order of the relevant elements.

The elements described with reference to terms such as unit, module, block, ~or, ~er, etc. used in the disclosure and the functional blocks shown in the drawings may be implemented in the form of software, hardware, or a combination thereof. For example, the software may be machine code, firmware, embedded code, and application software. For example, the hardware may include an electrical circuit, an electronic circuit, a processor, a computer, an integrated circuit, integrated circuit cores, passive components, or a combination thereof.

Hereinafter, “non-trusted execution environment”, “protected execution environment”, and “trusted execution environment” will be described as three different execution environments presented in some embodiments of the present disclosure.

As will be explained in more detail below, the present disclosure provides a method and an apparatus for providing a protected execution environment that supports an intermediate security level between a non-trusted execution environment and a trusted execution environment. Embodiments of the present disclosure do so, at least in one example, by using a computing device that supports a non-trusted execution environment and a protected execution environment, which operate in a Central Processing Unit (CPU) of a first state, and a trusted execution environment operating in a CPU of a second state separate from the first state.

First, in terms of security strength, the security strength is increased in the order of the non-trusted execution environment, the protected execution environment, and the trusted execution environment. In addition, in terms of a secure mode of a CPU, the non-trusted execution environment and the protected execution environment operate within the CPU in a non-secure mode, and the trusted execution environment operates within the CPU in a secure mode. For example, a flag indicating the non-secure mode or the secure mode may be stored in a register of the CPU. For example, in a TZMP architecture, the register of the CPU may be a “SCR_EL3” register, and the flag indicating the non-secure mode or the secure mode may be stored in “NS” bit of the “SCR_EL3” register.

The present disclosure may be interpreted by referring to the fact that the non-trusted execution environment is generally referred to as a non-trusted world, the protected execution environment is referred to as a protected world, and the trusted execution environment is referred to as a trusted world.

Also, in the TZMP architecture, transition of the execution environment between either the non-trusted execution environment or protected execution environment and the trusted execution environment may be performed by a secure monitor that is hardware in a security privilege layer, as described above, and transition of the execution environment between the non-trusted execution environment and the protected execution environment may be performed by preemption of a physical CPU by a virtual CPU (vCPU) allocated to a virtual machine that provides the protected execution environment.

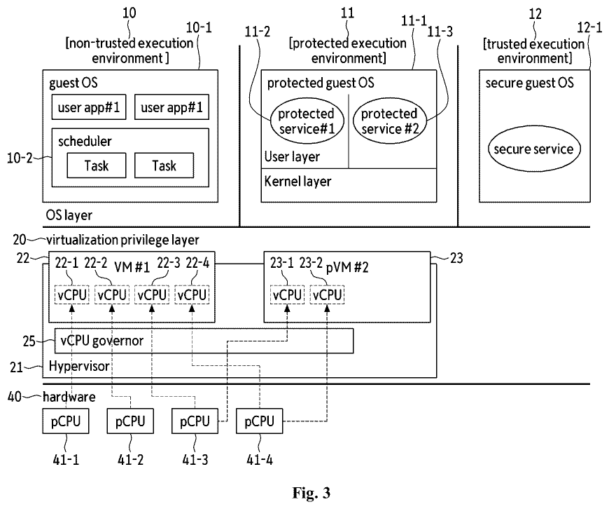

Hereinafter, a configuration and an operation of an exemplary SoC designed in accordance with an architecture for providing a virtualization technology based protected execution environment of a TZMP architecture according to one embodiment of the present disclosure will be described with reference to FIG. 3.

It is noted that the present embodiment may be applied to various types of computing devices including a computation means and a memory in addition to the SoC.

In an operating system layer of the SoC according to the present embodiment, a guest operating system 10-1 for a non-trusted execution environment 10, a protected guest operating system 11-1 for a protected execution environment 11, and a secure guest operating system 12-1 for a trusted execution environment 12 may be respectively installed. The guest operating system 10-1 may be installed on a first virtual machine (VM #1) 22 provisioned by a hypervisor 21 installed in a virtualization privilege layer 20 of the SoC. The protected guest operating system 11-1 may be installed on a second protected virtual machine (pVM #2) 23 provisioned by the hypervisor 21 installed in the virtualization privilege layer 20 of the SoC. The pVM #2 23 is referred to as a protected virtual machine in that it is a virtual machine that provides the protected execution environment 11.

The SoC according to the present embodiment supports a total of three different execution environments including the above-described trusted execution environment 12, non-trusted execution environment 10 and protected execution environment 11. In some embodiments of the present disclosure, a method for providing the trusted execution environment 12 and a method for controlling access to a memory address thereof may follow the TZMP architecture as it is. Accordingly, the embodiments of the present disclosure may be understood by referring to documents related to the trusted execution environment 12 based on the TZMP architecture.

Next, a method in which the hypervisor 21 of the SoC according to the present embodiment virtualizes physical CPUs 41-1, 41-2, 41-3 and 41-4, and allocates the resulting virtual CPUs 22-1, 22-2, 22-3, 22-4, 23-1 and 23-2 to the VM #1 22 and the pVM #2 23. A virtual CPU governor 25 of the hypervisor 21 may be responsible for allocating the virtual CPU to the VM.

The virtual CPU governor 25 may allocate one or more physical CPUs 41-1, 41-2, 41-3 and 41-4 of the SoC to the virtual machine. The virtual CPU governor 25 may allocate one physical CPU to one or a plurality of virtual machines. For example, FIG. 3 shows a result of the first physical CPU 41-1 being allocated to the VM #1 22, and a result of the second physical CPU 41-2 being also allocated to the VM #1 22.

In some embodiments, the virtual CPU governor 25 may also allocate the physical CPU allocated to the pVM #2 23, which is a protected virtual machine, to the VM #1 22, which is a general virtual machine that provides the non-trusted execution environment 10. That is, the third physical CPU 41-3 allocated to the pVM #2 23 may be allocated to the VM #1 22, and the fourth physical CPU 41-4 allocated to the pVM #2 23 may be also allocated to the VM #1 22.

The virtual CPU governor 25 may manage the general virtual machine and the protected virtual machine to share the physical CPU by allocating the physical CPUs 41-3 and 41-4 allocated to the pVM #2 23, which are protected virtual machines, to the VM #1 22.

Also, a method in which the general virtual machine and the protected virtual machine share the physical CPU may be a time divisional method. Accordingly, even though the pVM #2 23 which is a protected virtual machine is always created, the physical CPUs 41-3 and 41-4 allocated to the second virtual machine 23 may be utilized by the VM #1 22 which is a general virtual machine while the pVM #2 23 is not executing protected services 11-2 and 11-3, thereby preventing resources of the physical CPU from being wasted.

Since the physical CPU allocated to one virtual machine is virtualized to a single virtual CPU (vCPU), there will be no problem of occupying the physical CPU of the virtual CPU, but the physical CPU allocated to multiple virtual machines is virtualized to multiple virtual CPUs (vCPUs), resulting in a problem of occupying the physical CPU of the virtual CPU.

The virtual CPU governor 25 also allocates the physical CPU allocated to the protected virtual machine to the general virtual machine that provides the non-trusted execution environment 10 so that the problem of occupying the physical CPU of the virtual CPU between the protected virtual machine and the general virtual machine occurs.

In the situation illustrated in FIG. 3, the first virtual CPU 23-1 of the pVM #2 23 and the third virtual CPU 22-3 of the VM #1 22 will compete to occupy the third physical CPU 41-3. In addition, the second virtual CPU 23-2 of the pVM #2 23 and the fourth virtual CPU 22-4 of the VM #1 22 will compete to occupy the fourth physical CPU 41-4.

In some embodiments, the hypervisor 21 may determine a virtual CPU occupying the physical CPU in a priority-based preemption manner so that the virtual CPUs 23-1 and 23-2 of pVM #2 23 always have an advantage in the occupying competition for the physical CPUs 41-3 and 41-4 with the virtual CPUs 22-3 and 22-4 of the VM #1 22.

The hypervisor may set the priority of the protected virtual machine to be higher than that of the general virtual machine with respect to the physical CPU simultaneously allocated to the general virtual machine and the protected virtual machine. That is, in the situation illustrated in FIG. 3, the hypervisor 21 may set the priority of the pVM #2 23 to the physical CPUs 41-3 and 41-4 simultaneously allocated to the VM #1 22 and the pVM #2 23 to be higher than that of the VM #1 22. The hypervisor 21 may compare the priority of the virtual CPU of the pVM #2 23 with the priority of the virtual CPU of the VM #1 22, and may manage the virtual CPUs 23-1 and 23-2 of the pVM #2 to preempt the physical CPUs 41-3 and 41-4 in response to the compared result that the priority of the virtual CPU of the pVM #2 23 is higher than that of the virtual CPU of the VM #1 22.

The SoC of the present embodiment allows the virtual CPU of the general virtual machine to occupy the physical CPU allocated to the protected virtual machine when the virtual CPU allocated to the protected virtual machine is not executed, but when the protected service of the protected virtual machine is requested, allows the virtual CPU of the protected virtual machine to immediately preempt the physical CPU, thereby achieving effects of efficient resource utilization of the physical CPU and minimization of response time to the protected service.

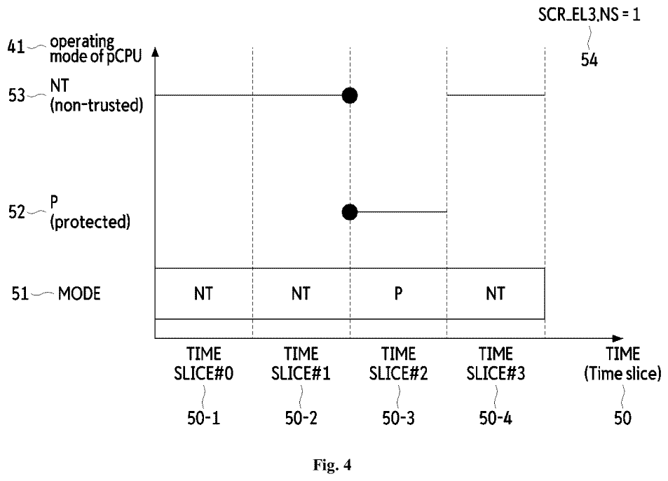

FIG. 4 is a diagram illustrating a mode switching process of a physical CPU of a SoC having an architecture for providing a TZMP2-based protected execution environment provided in some embodiments of the present disclosure. As shown in FIG. 4, when the virtual CPU of the general virtual machine and the virtual CPU of the protected virtual machine share one physical CPU in a time divisional manner, either a value 53 indicating a non-trusted execution environment NT or a value 52 indicating a protected execution environment P may be stored in a specific register provided in the SoC as a mode value 51.

As described above, when the mode value 51 of the physical CPU is the NT 53, the virtual CPU of the non-trusted execution environment occupies the physical CPU, and when the mode value 51 is changed to the P 52, the virtual CPU of the protected execution environment preempts the physical CPU. FIG. 4 illustrates a situation in which the virtual CPU of the non-trusted execution environment occupies the physical CPU as the mode value 51 is set to the NT 53 in time slice #0 and time slice #1 50-1 and 50-2 when two virtual CPUs share the physical CPU in a time divisional manner, the virtual CPU of the protected execution environment preempts the physical CPU as the mode value 51 is changed to the P 52 in time slice #2 50-3, and the virtual CPU of the non-trusted execution environment occupies the physical CPU again as the execution of the virtual CPU of the protected execution environment is completed in the time slice #2 50-3 and the mode value is updated to the NT 53 again in time slice #3 50-4.

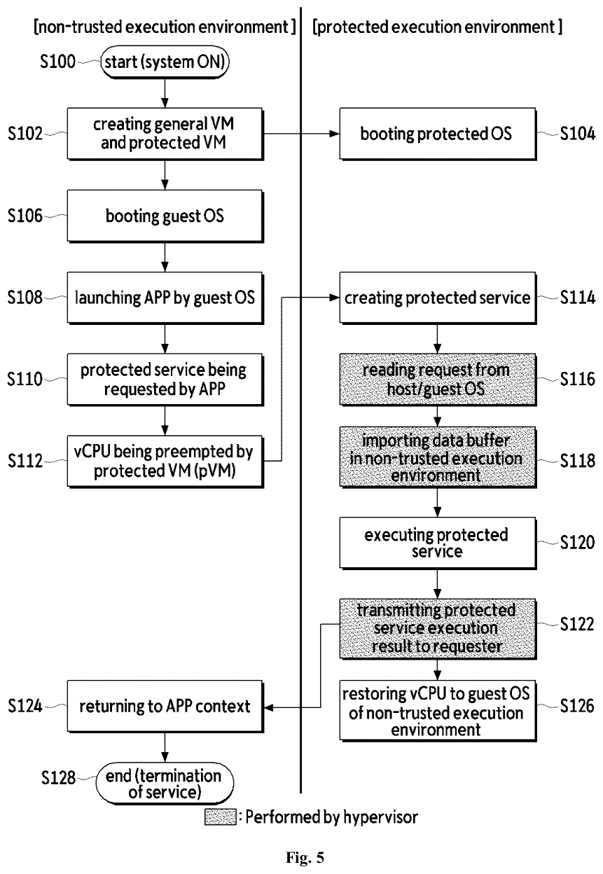

Hereinafter, a method for providing a protected service executed in a TZMP2-based protected execution environment according to another embodiment of the present disclosure will be described with reference to FIG. 5. FIG. 5 is a flow chart of a method for providing a protected service according to the present embodiment.

The present embodiment includes operations of the non-trusted execution environment and operations of the protected execution environment.

When the SoC is powered on (S100), the hypervisor may be booted in response to the power-on of the SoC, and a general virtual machine VM that provides a non-trusted execution environment and a protected virtual machine pVM that provides a protected execution environment may be created using the hypervisor (S102).

Next, the protected guest operating system installed in the protected virtual machine may be booted (S104), and the guest operating system of the general virtual machine may be booted (S106). In this case, in response to the completion of the booting of the hypervisor, the hypervisor may be able to automatically provision the general virtual machine VM in the non-trusted execution environment and the protected virtual machine pVM in the protected execution environment. In addition, the hypervisor may be able to boot the protected guest operating system by using the pVM automatically in response to the completion of the provisioning of the pVM. The meaning of ‘automatically’ may be understood to mean that when an event or action to be triggered occurs, a predesignated action is performed even though there is no specific manipulation by a user.

After the guest operating system is booted, applications installed in the guest operating system will be launched in accordance with the user's manipulation (S108).

When a specific application among the launched applications requests a protected service (S110), the virtual CPU of the pVM may preempt a physical CPU shared with the general virtual machine VM and the pVM (S112). The preemption process for the physical CPU has been described in detail with reference to FIGS. 3 and 4.

The protected service may be understood as a service that provides a higher level of security compared to a security level for an application executed in the non-trusted execution environment 10 by being executed in a verified protected guest OS 11-1 of a protected execution environment 11. For example, the application may satisfy a required level of security by processing tasks requiring intermediate level security, such as user authentication, payment, and DRM license verification, using the protected service.

When the virtual CPU of the pVM is executed by preemption (S112), the virtual CPU creates a protected service (S114), and the hypervisor may read a request received from the guest operating system or the host operating system, and then may deliver the read request to the pVM (S116).

Next, the hypervisor may import data for executing the read request from a data buffer allocated to a memory address space of the non-trusted execution environment (S118). The pVM receiving the imported data from the hypervisor may execute the protected service (S120). The hypervisor may transmit the execution result of the protected service to the application that is a requestor (S122). In this case, the hypervisor may deliver the execution result of the protected service to the virtual machine of the non-trusted execution environment through a data communication method between virtual machines.

As the execution result of the protected service is delivered to the application, context switching to the application will be performed (S124), and occupation of the physical CPU shared by the non-trusted execution environment and the protected execution environment will be returned to the virtual CPU of the non-trusted execution environment (S126). Thus, the operation when requesting the protected service in the non-trusted execution environment is terminated (S128).

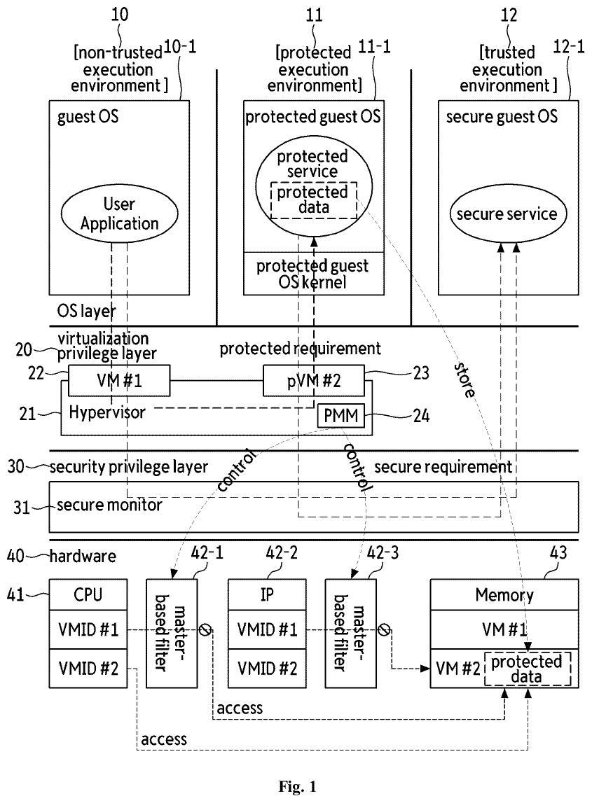

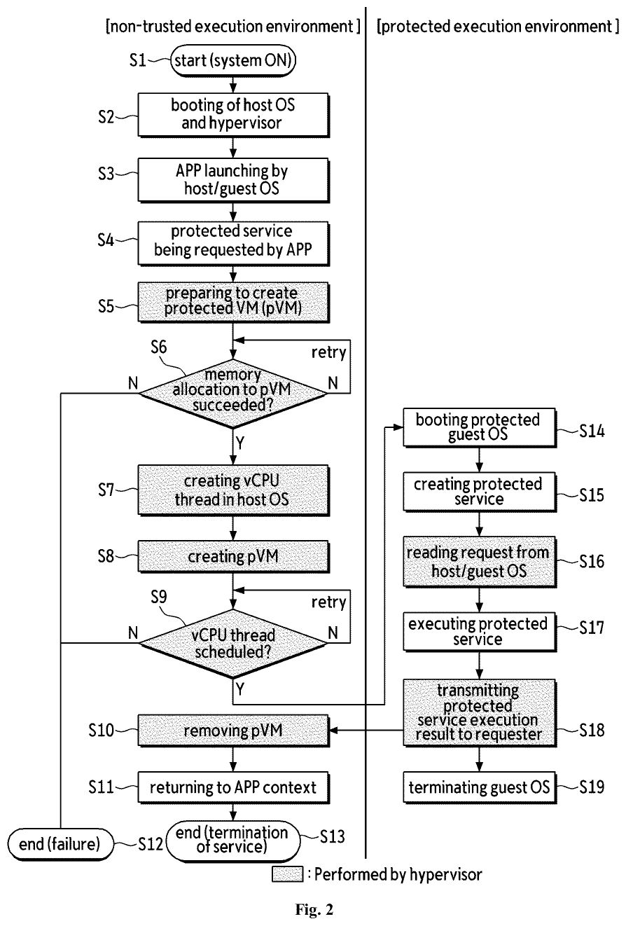

Unlike FIG. 1, the present embodiment described with reference to FIG. 5 differs from the related art described with reference to FIG. 2 in that the pVM is provisioned immediately in response to the system being powered on and the protected operating system of the pVM is booted (S104).

That is, in the present embodiment, the pVM is always activated and the protected guest operating system is always maintained in a booting state as long as the SoC is powered on, so that there is no need to make sure of a memory for creating the pVM and wait for scheduling of a virtual CPU task when the protected service is requested, unlike the method for providing a protected service according to the related art described with reference to FIG. 2. Therefore, the present embodiment may ensure real-time response to the request of the protected service. Nevertheless, the virtual CPU in the protected execution environment may not continuously occupy the physical CPU of the SoC, thereby making it efficient to utilize resources of the physical CPU.

As described above, the virtual CPU in the protected execution environment and the virtual CPU in the non-trusted execution environment always share a specific physical CPU, and the virtual CPU in the protected execution environment has a higher priority than the virtual CPU in the non-trusted execution environment, so that the virtual CPU in the protected execution environment will immediately preempt the specific physical CPU even though the specific physical CPU is occupied by the virtual CPU in the non-trusted execution environment at the time when the virtual CPU of the protected execution environment should be activated.

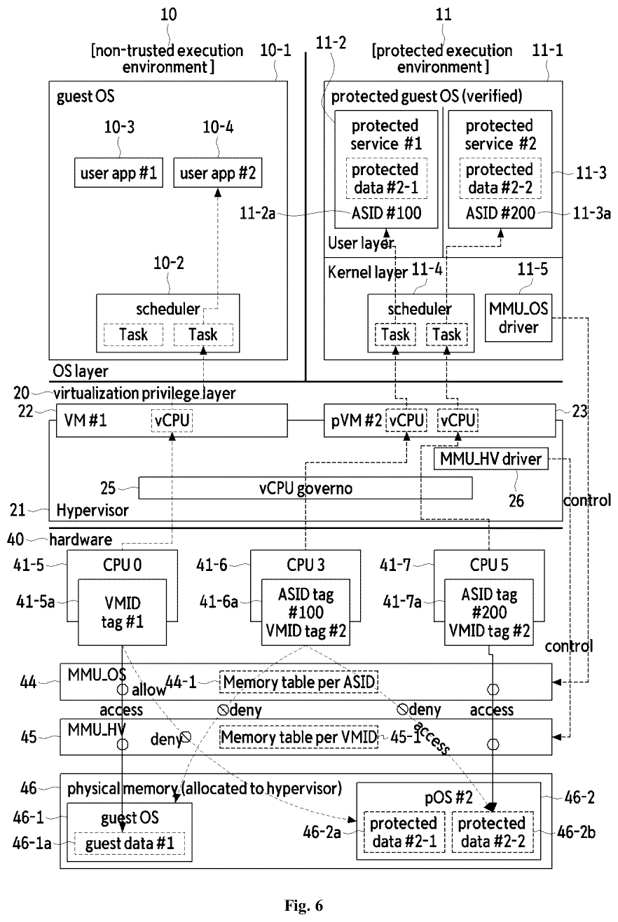

Hereinafter, a process of performing access control when a physical CPU provided in a SoC desires to access a specific address space of a memory in some embodiments of the present disclosure will be described with reference to FIG. 6. FIG. 6 is a diagram illustrating an example of performing hardware level memory access control for a CPU in an exemplary SoC designed in accordance with an architecture for providing a TZMP2-based protected execution environment provided in some embodiments of the present disclosure.

When an execution environment 11 protected by the number of services 11-2 and 11-3 is created in the SoC, the protected execution environment 11 may simultaneously and excessively preempt hardware resources such as the SoC's physical CPU and memory. In this case, the execution speed will slow down in the non-trusted execution environment.

In order not to cause the above-described problem, the protected execution environment is always activated together with power-on of the SoC, and in some embodiments of the present disclosure, a predesignated number of protected execution environments 11 will be created. The predesignated number may be one. The predesignated number may be a value set at the time of release of the SoC or recorded in a specific register provided in the SoC. In this case, a hypervisor that is booted when the SoC is powered on may create as many pVMs as the number of the protected execution environments 11 recorded in the specific register.

However, a single SoC needs to provide a plurality of protected services. For example, the SoC provided in the mobile communication terminal should be able to provide a first protected service that is a user authentication service using a personal identification number (PIN), and a second protected service that is a user authentication service using a fingerprint. In some embodiments of the present disclosure, a plurality of protected services in one protected execution environment 11 may be executed through different instances. For example, the first protected service 11-2 may be executed through a first process of the protected guest operating system, and the second protected service 11-3 may be executed through a second process of the protected guest operating system.

In relation to a function of performing memory access control so as not to invade a memory address space of another process, the protected guest operating system 11-1 may have been verified by a security agency. That is, the guest operating system 11-1 may be limited to having passed verification related to not invading the memory address space of another process unless a hacking technology is mobilized. Therefore, even though several protected services are executed inside one protected guest operating system 11-1, it may be understood that isolation in the memory address space between the protected services is performed at a software level.

In some embodiments of the present disclosure, hardware level memory access control may be performed so as not to invade the memory address space between the protected services 11-2 and 11-3 of the protected guest operating system 11-1, whereby isolation in the memory address space between the protected services at the software level may be performed more robustly even though several protected services are executed inside one protected guest operating system 11-1. Hereinafter, this embodiment will be described with reference to FIG. 6.

It is assumed that a first user app 10-3 and a second user app 10-4 are executed in the guest operating system 10-1 executed in the non-trusted execution environment 10 created using the VM #1 22. In addition, it is assumed that the first protected service 11-2 and the second protected service 11-3 are executed in the guest operating system 10-1 executed using the pVM #2 23.

In the protected execution environment 11, since two services of a first protected service 11-2 and a second protected service 11-2 are being executed, when either the first protected service 11-2 or the second protected service 11-2 is requested by the first user app 10-3 or the second user app 10-4, the virtual CPU of the pVM #2 23 preempts the physical CPU.

It can be seen that the virtual CPU governor 25 of the hypervisor 21 allocates one physical CPU to only one general virtual machine (VM) 22 or only one protected virtual machine (pVM) 23 unlike described with reference to FIG. 3.

In this way, when the plurality of protected services are executed in the protected execution environment, a plurality of physical CPUs may be allocated to the pVM of the protected execution environment, wherein each physical CPU is not shared with the virtual machine 22 in the non-trusted execution environment, and the protected virtual machine may monopolize one or more physical CPUs. As a result, stability of the physical CPU allocation for the plurality of protected services executed in the protected execution environment may be enhanced.

In some embodiments, the hypervisor 21 may increase the number of virtual CPUs allocated to the pVM that provides the protected execution environment, as the number of protected services executed in the protected execution environment increases. This dynamic allocation of the virtual CPUs may be performed through monitoring of the number of protected services by the hypervisor 21.

In this regard, a more detailed description will be given. The hypervisor 21 may allocate at least one virtual CPU to the VM #1 22 and the pVM #2 23, especially may allocate a first virtual CPU and a second virtual CPU to the pVM #2 23. In addition, a scheduler 11-4 of the protected guest operating system 11-1 of the pVM #2 23 may perform task scheduling so that a task of the first protected service 11-2 is performed using the first virtual CPU and a task of the second protected service 11-3 is performed using the second virtual CPU. That is, in some embodiments, each individual virtual CPU is allocated to each protected service, so that different protected services may obtain an effect of parallel processing through individual virtual CPUs. The virtual CPU governor 25 may map each virtual CPU and physical CPU, which process the tasks of the protected services, on a 1:1 basis. As a result, efficiency of parallel processing of the different protected services described above may be further increased.

Hereinafter, embodiments of performing hardware level memory access control so as not to invade memory address spaces between protected services of the protected guest operating system 11-1 will be described.

This hardware level memory access control may be performed by using a memory management unit 44 of a first stage implemented by hardware so that protected services operating in different processes inside the same virtual machine do not invade an address space of a memory, and using a memory management unit 45 of a second stage implemented by hardware so as not to invade address spaces of memories of different virtual machines. In this regard, a more detailed description will be given below.

Each of the first protected service 11-2 and the second protected service 11-3 may be given a unique address space ID (ASID). In FIG. 6, it is shown that an address space identifier (ASID) 11-2a of the first protected service 11-2 is #100, and an address space identifier (ASID) 11-3a of the second protected service 11-3 is #200.

Each protected service may request an ASID tag driver (not shown) of the hypervisor 21 to attach an ASID tag implemented in hardware to a transaction output by the physical CPU.

As a result, #100, which is the ASID of the first protected service 11-2, is tagged as an ASID tag 41-6a in the memory access transaction that that is output to a system interconnector (not shown) by a physical CPU 41-6 allocated to the first protected service 11-3. In addition, #200, which is the ASID of the second protected service 11-3, is tagged as ASID tag 41-7a in the memory access transaction that is output to the system interconnector (not shown) by a physical CPU 41-7 allocated to the second protected service 11-3.

The memory management unit 44 of the first stage may map an address space of a physical memory corresponding to the transaction by using the ASID included in the transaction.

Through the memory management unit 44 of the first stage implemented by hardware, transactions output by the physical CPUs 41-6 and 41-7 will access only the address space of the memory corresponding to the address space identifier tagged in the transactions.

The memory management unit 44 of the first stage may store a memory address table 44-1 for each ASID. In embodiments, adjustment to a size or a position of the memory address space of each protected service may be needed, update to the identifier ASID of the memory address space may be required. In this case, the protected guest operating system 11-1 may control the memory management unit 44 of the first stage to update the memory address table 44-1 for each ASID by using a first stage memory management unit_operating system driver (MMU_OS driver) 11-5.

Next, hardware level memory access control that prevents the memory address space of VM #1 22 and the memory address space of pVM #2 23 from invading each other will be described.

After provisioning the virtual machine, the hypervisor 21 may assign a unique identifier to each virtual machine. The hypervisor 21 may request a second stage memory management unit_hyperviser driver (MMU_HV driver) 26 to attach a VMID tag implemented in hardware to a transaction output by the physical CPU.

FIG. 6 illustrates a result in which a VMID tag 41-5a of the VM #1 22 is attached to a transaction output from a physical CPU 41-5 allocated to the VM #1 22, and the VMID tags 41-6a and 41-7a of the pVM #2 23 are attached to the transactions output from the physical CPUs 41-6 and 41-7 allocated to the pVM #2 23.

The transactions output by the physical CPUs 41-5, 41-6 and 41-7 will force access to the address space of the memory corresponding to the virtual machine identifier VMID of each virtual machine to which the physical CPUs 41-5, 41-6 and 41-7 are allocated through the memory management unit 45 of the second stage implemented in hardware. The memory management unit 45 of the second stage may store a memory address table 45-1 for each VMID.

When a free memory address space due to the size of the memory address space of each virtual machine or removal of the virtual machine is required, update of the memory address space for each identifier VMID of each virtual machine will be required. In this case, the hypervisor 21 may control the memory management unit 45 of the second stage to update the memory address table 45-1 for each VMID by using the MMU_HV driver 26.

Meanwhile, as shown in FIG. 6, the physical memory 46 of an area including memory address spaces corresponding to the guest operating system 10-1 and the protected guest operating system 11-1 may be allocated to the hypervisor 21. This is because that the hypervisor 21 is a type-1 hypervisor that can operate by itself without the need for an operating system. Since the physical memory 46 is allocated to the hypervisor 21, the hypervisor 21 may freely access each memory address space in the physical memory 46, thereby allowing the hypervisor 21 to check whether the memory address space corresponding to each VMID needs to be updated.

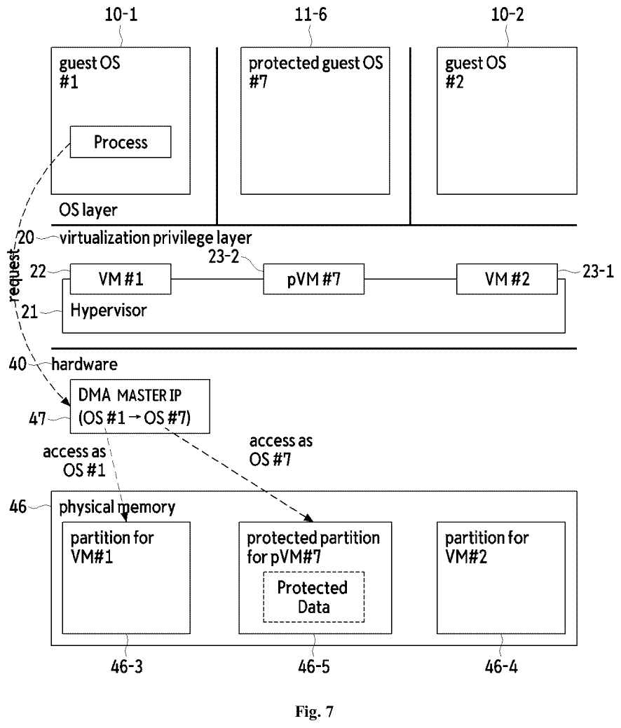

Next, a first example in which hardware level access control is performed so that a DMA master IP may accurately access an address space of a memory of a protected service in an exemplary SoC designed in accordance with an architecture for providing a TZMP2-based protected execution environment provided in some embodiments of the present disclosure will be described with reference to FIG. 7. The present embodiment may be understood as a method of controlling access so that the DMA master IP accurately accesses the address space of the memory of the protected service in the TZMP2-based protected execution environment. The DMA master IP means an electronic property (IP) that may directly access the physical memory 46 based on DMA technology.

The hypervisor 21 of the virtualization privilege layer 20 of the SoC according to the present embodiment provisions two general virtual machines VM #1 22 and VM #2 23-1 for two guest OSs OS #1 10-1 and OS #2 10-2 and one protected virtual machine pVM #7 23-2 for the protected guest OS OS #7 11-6.

The DMA master IP 47 may tag VMID of an owner VM of the DMA master IP 47 when creating a transaction to access the physical memory 46.

In the present embodiment, the hypervisor 21 may set a VMID tag for the DMA master IP 47 depending on whether a request for the DMA master IP output from the guest OSs OS #1 10-1 and OS #2 10-2 is for a non-trusted process or a protected service call. For example, when the request of the process of the guest OS #1 10-1 is for a non-trusted process, the hypervisor 21 may control the memory access transaction of the DMA master IP 47 to access a partition 46-3 for the VM #1 22 by setting the VMID tag of the DMA master IP 47 to the VMID of the VM #1 22. In addition, when the request of the process of the guest OS #1 10-1 is for a protected service call, the hypervisor 21 may control the memory access transaction of the DMA master IP 47 to access a protected partition 46-5 for the pVM #7 by setting the VMID tag of the DMA master IP 47 to the VMID of the pVM #7 23-2.

As shown in FIG. 7, when the VM and the memory partition correspond to each other on a one-to-one basis, the transaction for memory access of the DMA master IP 47 may be controlled to access only the correct partition by controlling the VMID tag of the DMA master IP 47.

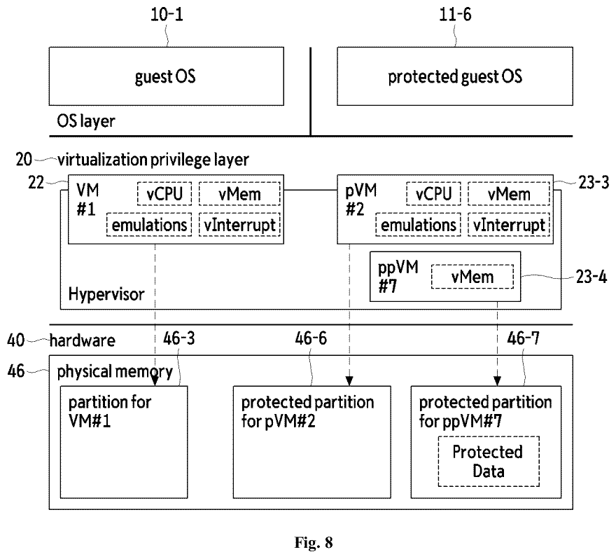

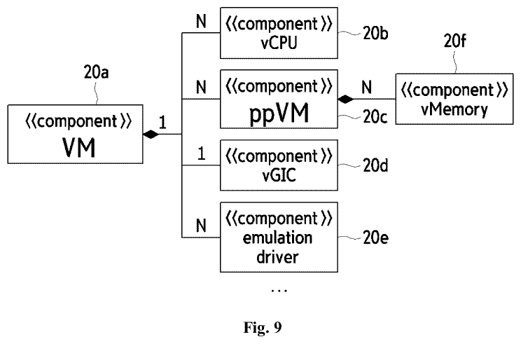

FIGS. 8 to 9 are diagrams illustrating a protected partition virtual machine ppVM referenced in some embodiments of the present disclosure. In some embodiments of the present disclosure, a protected partition virtual machine ppVM may be created to hardware-control the DMA master IP not to access an incorrect partition. As shown in FIG. 8, the hypervisor may provision the VM #1 22 of the guest OS 10-1 for providing a non-trusted execution environment and the pVM #2 23-3 of the protected guest OS 11-6 for providing a protected execution environment.

The VM #1 22 and the pVM #2 23-3 include virtual resources such as a virtual CPU, a virtual memory, a hardware emulation, and a virtual interrupt to function as compute instances.

When a plurality of protected services are executed in the protected guest OS 11-6, the hypervisor may provision the number of ppVMs corresponding to the number of protected services to be executed. The number of ppVMs may be obtained by subtracting 1 from the number of protected services. For example, when the number of protected services executed in the protected guest OS 11-6 is two, the hypervisor may create one ppVM #7 23-4.

The ppVM #7 23-4 has only a virtual memory, unlike the VM #1 22 and the pVM #2 23-3 which function as compute instances. However, the ppVM 23-4 is also allocated a unique VMID in the same way as the VM #1 22 and the pVM #2 23-3.

FIG. 8 shows a protected partition 46-7 corresponding to the ppVM #7 23-4, a partition 46-3 for the VM #1 22, and a protected partition 46-6 for the pVM #2 23-3. Since the ppVM #7 23-4 is intended to provide a partition for any one of two protected services executed in one protected guest OS 11-6 and does not provide a compute instance, the ppVM #7 has a position that is logically dependent on the pVM #2 23-3 in which the protected guest OS 11-6 is installed.

As shown in FIG. 9, a VM component 20a may include a plurality of virtual CPU components 20b, a single virtual generic interrupt controller component 20d, a plurality of virtual emulation drivers 20e, and a plurality of virtual memory components (not shown). The VM component 20a may be a component of a pVM.

Also, as shown in FIG. 9, one VM component 20a may include a plurality of ppVM components 20c. The VM component 20a may be responsible for one protected service, and the ppVM components 20c equivalent to the remaining number of protected services excluding 1 from a total number of protected services may correspond to the VM component. Furthermore, as described above, the ppVM component 20c may include only a virtual memory component 20f. The ppVM component 20c may include a plurality of virtual memory components 20f. In this specification, the term “component” is used to indicate a functional or logical element for explaining the configuration and relationships of the virtual machine and other elements, and does not necessarily denote a physically distinct or independently executable unit. The term is employed to clearly describe structural associations among elements such as the vCPU, vGIC, ppVM, and vMemory.

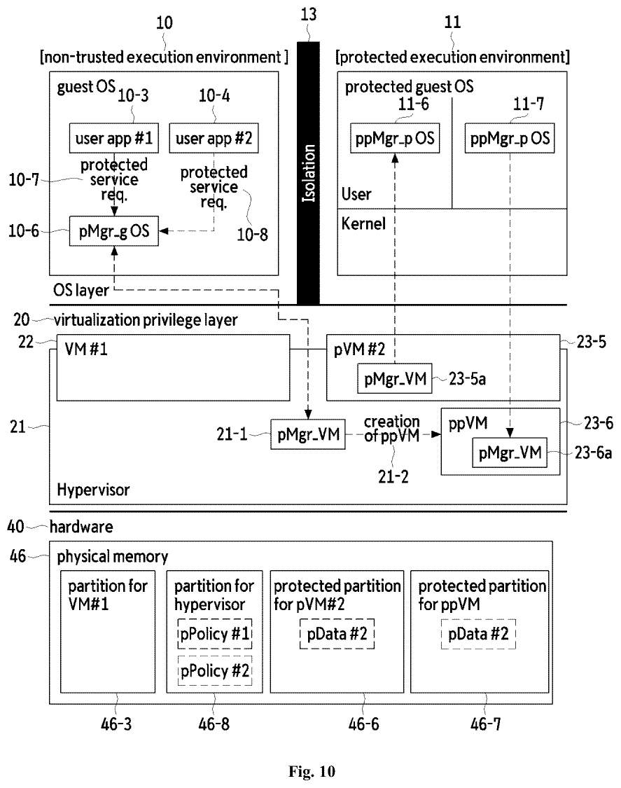

FIG. 10 is a diagram illustrating a second example of hardware level access control performed so that a DMA master IP may accurately access an address space of a memory of a protected service in an exemplary SoC designed in accordance with an architecture for providing a TZMP2-based protected execution environment provided in some embodiments of the present disclosure. FIG. 10 illustrates an example in which memory partitions of each protected service are hardware-isolated using the above-described ppVM.

Referring to FIG. 10, a user app #1 10-3 and a user app #2 10-4 are executed in the guest OS that provides the non-trusted execution environment 10, and a first protected service and a second protected service are executed in the protected guest OS that provides the protected execution environment 11. The first protected service may be executed through a first process of the protected guest OS, and the second protected service may be executed through a second process of the protected guest OS. The first protected service may be executed through a first container of the protected guest OS, and the second protected service may be executed through a second container of the protected guest OS.

An isolation 13 between the protected partition 46-6 of the physical memory 46 of the first protected service 46 and the protected partition 46-7 of the physical memory 46 of the first protected service and the partition 46-3 of the physical memory 46 of the user apps 10-3 and 10-4 may be understood as hardware isolation using the second type of MMU hardware, as described with reference to FIG. 6.

When the user app #1 10-3 or the user app #2 10-4 requests a protected service (10-7 and 10-8), a protect manager on guest OS (pMgr_gOS) 10-6 receives the requests 10-7 and 10-8.

The pMgr_gOS 10-6 is a software component operating in the guest OS and creates a protection descriptor. The protection descriptor means information on a requested service.

The pMgr_gOS 10-6 provides the above protection descriptor to a protect Manager on hypervisor (pMgr_HV) 21-1 of the hypervisor. The pMgr_HV 21-1 is a software component that controls the entire protection scenario in the hypervisor, and may deliver the requested protection descriptor to a protect policy Manager on protect guest OS (ppMgr_pOS) 11-6, which is in charge of the protected service, through each protect manager on virtual machine (ppMgr_pOS) 23-5a, and may receive an Accept/Deny response from the ppMgr_pOS 11-6, which means a review result of whether the above request conforms to a protect policy (pPolicy).

Each of the first protected service and the second protected service includes ppMgr_pOS 11-6 and 11-7. The ppMgr_pOS 11-6 and 11-7 may access a partition 46-8 of the hypervisor, and performs policy inspection with reference to protect Policy (pPolicy) information stored in the partition 46-8 of the hypervisor. That is, each of the first protected service and the second protected service may deny a protected service request that violates the policy through the ppMgr_pOS 11-6 and 11-7.

The pMgr_HV 21-1 may immediately deliver the protected service to the requested user apps 10-3 and 10-4 when the Deny response is received from the ppMgr_pOS 11-6.

The pMgr_VM 23-5a may draft a protection requirement when the accept response is received from the ppMgr_pOS 11-6. The protection requirement may include various kinds of information that should be referenced to process a protected service request, and may include, for example, memory buffer information, VMID information, R/W access right per VMID for an MMU, R/W access right per VMID for an IOMMU, DMA MASTER IP Stream ID, and the like. The pMgr_VM 23-5a may deliver the protection requirement to the pMgr_HV 21-1.

The pMgr_HV 21-1 may parse the protection requirement, declare a memory partition, or match the memory partition with the existing partition, and may generate a signal for creating a ppVM (21-2) if necessary, to create a ppVM 23-6. As described above, a protected partition for a ppVM may be matched with the ppVM 23-6.

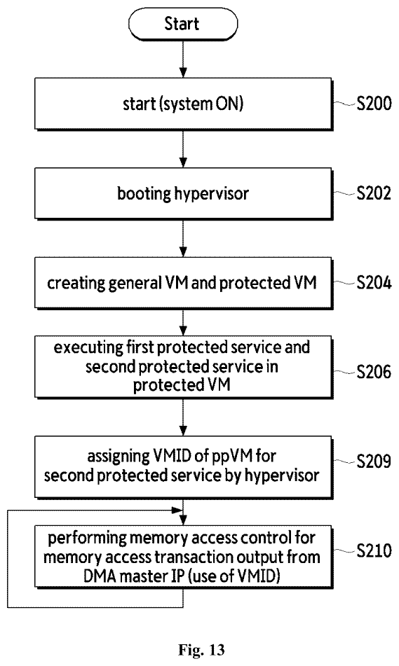

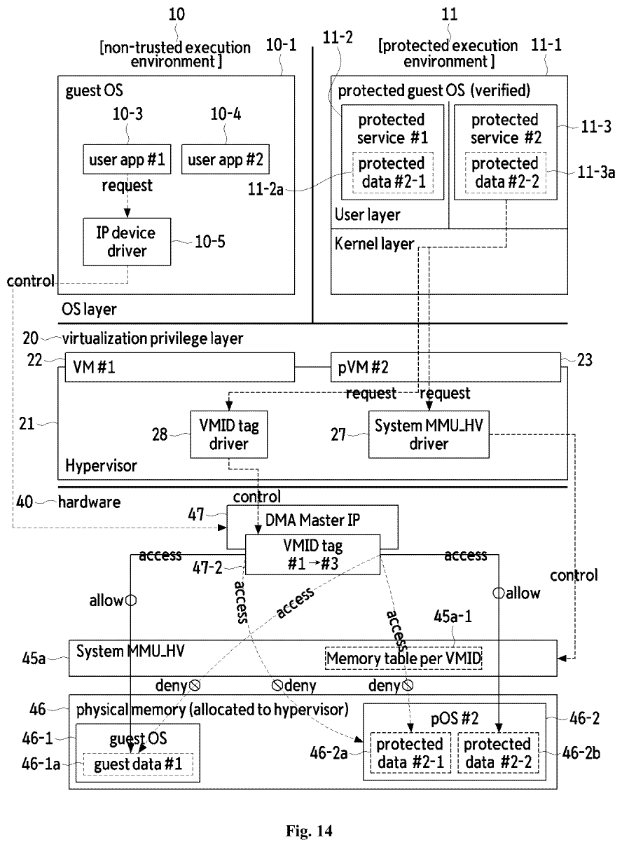

Communication between software modules supporting hardware level access control for memory access of the DMA master IP to be performed using the ppVM has been described with reference to FIG. 10. Through the above-described structure, even though a plurality of protected services are executed through one protected guest OS, one or more ppVMs belonging to one pVM are created and the protected partition is matched with each ppVM, whereby hardware memory partition access control using a second stage MMU may be performed. Hereinafter, embodiments related to memory access control of the DMA master IP using the ppVM will be described in detail with reference to FIGS. 13 and 14.

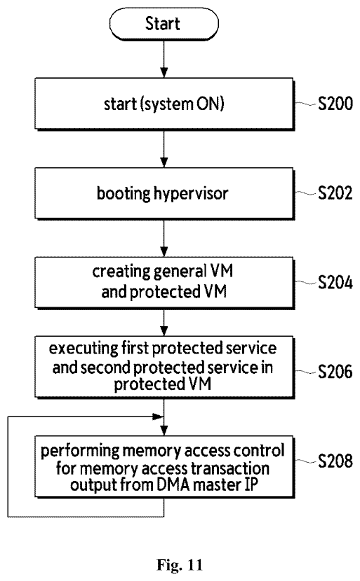

Next, a method for controlling access to a memory address space of the DMA master IP according to another embodiment of the present disclosure will be described with reference to FIG. 11. The present embodiment may be understood as a method for controlling access so that the DMA master IP accurately accesses the address space of the memory of the protected service in the TZMP2-based protected execution environment.

First, after the SoC is powered on (S200), the hypervisor is booted (S202), a non-trusted virtual machine (general VM) and a protected virtual machine are created (S204). Next, a plurality of protected services are executed using the protected virtual machine (S206).

Next, memory access control of the memory access transaction output from the DMA master IP may be performed through the memory management unit of the first stage and the memory management unit of the second stage having a memory table for each virtual machine identifier (VMID) (S208). In this case, the memory management unit of the first stage may specify an accessible address space of the memory access transaction among the memory spaces of the second virtual machine by using at least one of a port, a stream ID or an address space identifier (ASID) of the memory access transaction.

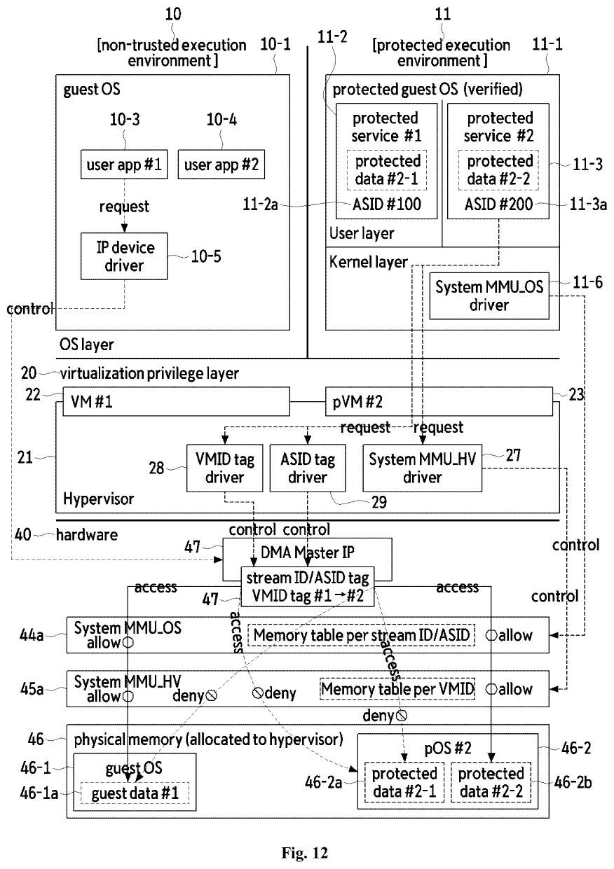

The present embodiment will be described in more detail with reference to FIG. 12. FIG. 12 is a diagram illustrating a third example of hardware level access control performed so that a DMA master IP may accurately access an address space of a memory of a protected service in an exemplary SoC designed in accordance with an architecture for providing a TZMP2-based protected execution environment provided in some embodiments of the present disclosure.

The embodiment shown in FIG. 12 describes a hardware-based access control method in which the DMA master IP accurately accesses the physical memory area of the protected service that uses the DMA master IP when either the first protected service 11-2 or the second protected service 11-3 uses the DMA master IP. For example, the DMA master IP may be a camera sensor IP, a fingerprint sensor IP, or an encryption accelerator IP.

It is assumed that the first user app 10-3 of the non-trusted execution environment 10 transmits a control signal to the DMA master IP 47 through a driver 10-5 of the DMA master IP 47 installed in the guest operating system 10-1 and transmits a service request for the second protected service 11-3 to the second protected service 11-3.

It is assumed that the second protected service 11-3 should use the DMA master IP 47 to execute a service. In order for the DMA master IP 47 to accurately access the address space of the physical memory 46 mapped to the second protected service 11-3, the second protected service 11-3 may request the VMID tag driver 28 included in the hypervisor 21 to attach the VMID tag implemented in hardware to the transaction output by the DMA master IP 47.

When the second protected service 11-3 or the first protected service 11-2 uses the DMA master IP 47, the tag of the VMID #2, which is the VMID of the pVM #2, may be attached to the transaction output from the DMA master IP 47. On the other hand, when the first user application 10-3 or the second user application 10-4 uses the DMA master IP 47, the tag of the VMID #1, which is the VMID of the VM #1 22, may be attached to the transaction output from the DMA master IP 47.

FIG. 12 illustrates that when the VMID #1 is tagged in the transaction output by the DMA master IP 47, access to the memory address space 46-1 of the guest operating system 10-1 installed on the VM #1 22 is allowed by a first stage memory management unit (System MMU_OS) 44a and a second stage memory management unit (System MMU_HV) 45a, and when the VMID tagged in the transaction output by the DMA master IP 47 is changed from the VMID #1 to the VMID #2, access to a memory address space 46-2 of the protected guest operating system 11-1 in which the first protected service 11-2 or the second protected service 11-3 is installed is allowed by the first stage memory management unit (System MMU_OS) 44a and the second stage memory management unit (System MMU_HV) 45a.

When hardware level memory access control is to be performed for the memory address space 46-2 corresponding to the address space identifier (ASID) #100 11-2a of the first protected service 11-2 and the memory address space 46-2b corresponding to the address space identifier (ASID) #200 11-3a of the second protected service 11-3 by further subdividing the access to the memory address space 46-2 of the guest operating system 11-1, the ASID tag hardware of the DMA master IP may be instructed to add an ASID tag in addition to the VMID tag.

When the second protected service 11-3 uses the DMA master IP 47, the second protected service 11-3 may request the ASID tag driver 29 included in the hypervisor 21 to attach the ASID tag implemented in hardware to the transaction output by the DMA master IP 47 as ASID #200 which is the ASID of the first protected service 11-2. In this case, when the transaction output by the DMA master IP 47 intends to access the address space of the memory 46 corresponding to the memory address space identifier 11-2a of the first protected service 11-2, the first stage memory management unit (System MMU_OS) 44a will deny the memory access request of the transaction.

The method for controlling access to a memory address space of a DMA master IP according to the present embodiment will be summarized as follows.

The method for controlling access to a memory address space of a DMA master IP according to the present embodiment may be understood as a method performed by a computing device that supports a non-trusted execution environment operating in a central processing unit (CPU) of a first state, a trusted execution environment operating in a CPU of a second state separate from the first state, and a protected execution environment.

First, the hypervisor installed in the computing device may be booted in response to power-on of the computing device. Next, the first virtual machine that provides the non-trusted execution environment and the second virtual machine that provides the protected execution environment may be provisioned using the hypervisor.

Next, the protected guest operating system of the second virtual machine may execute a first protected service as a first instance, and may execute a second protected service, which is a service different from the first protected service, as a second instance. Next, the memory access transaction output from the DMA master IP may perform memory access control of the memory access transaction through the memory management unit of the first stage and the memory management unit of the second stage having a memory table for each virtual machine identifier (VMID).

In this case, the memory management unit of the first stage may specify an accessible address space of the memory access transaction among the memory areas of the second virtual machine by using at least one of a port, a stream ID or an address space identifier (ASID) of the memory access transaction.

In this case, as described above, the hypervisor installed in the computing device may be a type-1 hypervisor installed directly in the computing device without an operating system.

In some embodiments, during the execution of the first protected service, the first protected service may provide the address space ID (ASID) tag driver of the hypervisor with an ASID tag request of the first protected service to the DMA mater IP provided in the computing device. In addition, the first protected service may provide the virtual machine ID (VMID) tag driver of the hypervisor with a VMID tag request of the second virtual machine for the DMA master IP.

In this case, in specifying the accessible address space of the memory access transaction among the memory areas of the second virtual machine, the accessible address space of the memory access transaction may be specified as the address space of the first protected service in response to the case that the address space identifier (ASID) of the first protected service is included in the memory access transaction.

In addition, in response to the case that the address space identifier (ASID) is not included in the memory access transaction and the port of the memory access transaction corresponds to the first protected service, the accessible address space of the memory access transaction may be specified as the address space of the first protected service. In this case, in response to the case that the address space identifier (ASID) is not included in the memory access transaction and the port and the stream ID of the memory access transaction correspond to the first protected service, the accessible address space of the memory access transaction may be specified as the address space of the first protected service.

Hereinafter, a method for accessing a memory address space of a DMA master IP according to another embodiment of the present disclosure will be described with reference to FIG. 13.

First, after the SoC is powered on (S200), the hypervisor is booted (S202), and the non-trusted virtual machine (general VM) and the protected virtual machine are created (S204). Next, a plurality of protected services are executed using the protected virtual machine (S206).

Next, the hypervisor creates (number—1) ppVMs of protected services for the plurality of protected services. In this case, the hypervisor creates a ppVM having only a memory address space, and it can be understood that a unique VMID is created for each ppVM. In this case, even though a plurality of protected services are executed in one protected virtual machine, each of the plurality of protected services has a different VMID, so that the DMA master IP may accurately access the memory address space of the protected service by using the second stage memory management unit (System MMU_HV).

FIG. 14 is a diagram illustrating a fourth example of hardware level access control performed so that a DMA master IP may accurately access an address space of a memory of a protected service in an exemplary SoC designed in accordance with an architecture for providing a TZMP2-based protected execution environment provided in some embodiments of the present disclosure.

In FIG. 14, the hypervisor 21 may assign a virtual machine identifier VMID #3 of one ppVM in addition to the VMID #2 of the pVM #2 23 itself. This is because that two protected services 11-2 and 11-3 are executed in the pVM #2 23. For example, the hypervisor 21 may assign VMID #2 to the first protected service 11-2 and assign the virtual machine identifier VMID #3 of the ppVM to the second protected service 11-3.

When the second protected service 11-3 intends to use the DMA master IP 47, the second protected service 11-3 may provide the VMID tag driver 28 located in the hypervisor 21 with a VMID tag request to the virtual machine identifier VMID #3 of the ppVM for the DMA master IP 47. In this case, the tag of the VMID #3 may be attached to the transaction output by the DMA master IP 47 (47-2).

The hypervisor 21 may control the memory management unit 45a of the second stage through a memory management unit driver (SystemMMU_HV driver) 27 of the second stage to update a memory address space table 45a-1 for each VMID, which is stored in the memory management unit 45a of the second stage when assigning a new VMID or a virtual machine identifier of a new ppVM.

The transaction output by the DMA master IP 47 and tagged with VMID #3 cannot access a memory area 46-2a of the first protected service. Since the VMID of the memory area of the first protected service is VMID #2, the memory management unit 45a of the second stage will hardware-deny the memory access request. On the other hand, the transaction output by the DMA master IP 47 and tagged with VMID #3 may access the memory area 46-2a of the second protected service. Since the VMID of the memory area of the second protected service is VMID #3, the memory management unit 45a of the second stage will allow the transaction with reference to the memory table 45a-1 for each VMID.

The embodiment referring to FIGS. 13 and 14 will be summarized as follows. In this embodiment, in a method performed by a computing device supporting a non-trusted execution environment and a protected execution environment, which operate in a central processing unit (CPU) of a first state, and a trusted execution environment operating in a CPU of a second state CPU separate from the first state, the hypervisor installed in the computing device is booted in response to power-on of the computing device, a first virtual machine that provides the non-trusted execution environment and a second virtual machine that provides the protected execution environment are provisioned using the hypervisor, a protected guest operating system of the second virtual machine executes a first protected service as a first instance and executes a second protected service different from the first protected service as a second instance, the hypervisor assigns a virtual machine identifier (VMID) of a ppVM for the second protected service, the second protected service provides a virtual machine ID (VMID) tag driver of the hypervisor with a VMID tag request of the virtual machine identifier of the ppVM for a DMA master IP, and memory access control to an address space of the second protected service may be performed for a memory access transaction output by the DMA master IP through a memory management unit of a second stage having a memory table for each VMID. The hypervisor installed in the computing device may be a type-1 hypervisor installed directly in the computing device without an operating system.

In this case, the hypervisor may create a ppVM having only a memory partition indicating the address space of the second protected service and assign the virtual machine identifier (VMID) of the created ppVM to the second protected service, so that each protected service performed in one protected virtual machine is allocated a different virtual machine identifier (VMID).

Although the embodiments of the present disclosure have been described with reference to the accompanying drawings, it will be apparent to those skilled in the art that the present disclosure may be fabricated in various forms without being limited to the above-described embodiments and may be embodied in other specific forms without departing from the technical spirits and essential characteristics. Thus, the above embodiments are to be considered in all respects as illustrative and not restrictive.

Various example embodiments of the disclosure and effects according to the example embodiments have been described with reference to FIGS. 1 to 14. The effects according to the technical idea of the disclosure are not limited to the effects mentioned above, and other effects not described may be clearly understood by those skilled in the art from the description above.

The technical ideas of the disclosure described so far may be implemented as computer-readable code on a computer-readable medium. The computer program recorded on the computer-readable recording medium may be transmitted to another computing device through a network such as the Internet, installed on the other computing device, and thus used on the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. Although embodiments of the disclosure have been described above with reference to the attached drawings, those skilled in the art will understand that the disclosure may be implemented in other specific forms without changing the technical idea or essential features. The example embodiments described above should be understood in all respects as illustrative and not restrictive. The scope of protection of the disclosure should be interpreted in accordance with the claims below, and all technical ideas within the equivalent scope should be construed as being included in the scope of rights of the technical ideas defined by this disclosure.

What is claimed is:

1. A method for providing a protected execution environment, the method being performed by a computing device,
wherein the computing device supports a non-trusted execution environment, the protected execution environment, and a trusted execution environment, and wherein the non-trusted execution environment and the protected execution environment operate within a central processing unit (CPU) in a first state, and the trusted execution environment operates within a CPU in a second state, which is separate from the first state, and the method comprises:
booting a hypervisor installed on the computing device in response to power-on of the computing device;
provisioning a first virtual machine that provides the non-trusted execution environment and a second virtual machine that provides the protected execution environment, by using the hypervisor;
executing a second virtual CPU of the second virtual machine by using virtual CPU preemption and pausing execution of a first virtual CPU of the first virtual machine based on a request for a first protected service during execution of a first application, the first application being executed on a general guest operating system of the first virtual machine;
executing the first protected service on a protected guest operating system of the second virtual machine;
providing a result of the first protected service to the first application; and
returning a physical CPU allocated to the second virtual CPU of the second virtual machine subsequent to completing the first protected service, the physical CPU being from among one or more Physical CPUs of the computing device,
wherein the hypervisor in the computing device is a type-1 hypervisor installed directly in the computing device without an operating system.

2. The method of claim 1, wherein the provisioning of the first virtual machine and the second virtual machine includes:
automatically provisioning the first virtual machine and the second virtual machine subsequent to completion of a booting of the hypervisor; and
booting the protected guest operating system of the second virtual machine subsequent to completion of provisioning of the second virtual machine.

3. The method of claim 1, wherein the hypervisor manages the one or more physical CPUs of the computing device by allocating the one or more physical CPUs to one or more virtual machines, and
wherein the hypervisor allocates the physical CPU allocated to the second virtual machine simultaneously to the first virtual machine and the second virtual machine.

4. The method of claim 3, wherein the hypervisor manages at least some physical CPUs of the computing device to be exclusively allocated to the first virtual machine.

5. The method of claim 3, wherein the executing the second virtual CPU and the pausing the execution of the first virtual CPU comprises:
executing the second virtual CPU of the second virtual machine and pausing the execution of the first virtual CPU of the first virtual machine in a virtual CPU (vCPU) preemption manner subsequent to the first application entering a waiting state until a response to the request of the first protected service is provided after the first protected service is requested during execution of the first application.

6. The method of claim 3, wherein the physical CPU simultaneously allocated to the first virtual machine and the second virtual machine is simultaneously allocated to the first virtual machine and the second virtual machine in a time divisional manner.

7. The method of claim 3, wherein the executing the second virtual CPU and the pausing the execution of the first virtual CPU comprises:
comparing a priority of the second virtual CPU of the second virtual machine with a priority of the first virtual CPU of the first virtual machine; and
preempting the physical CPU allocated to the first virtual machine and the second virtual machine by the second virtual CPU of the second virtual machine and executing the second virtual CPU of the second virtual machine using the physical CPU, based on the priority of the virtual CPU of the second virtual machine being higher than the priority of the virtual CPU of the first virtual machine.

8. The method of claim 1, wherein the protected guest operating system of the second virtual machine executes the first protected service as a first instance, and executes a second protected service, which is a service different from the first protected service, as a second instance, and
the executing the second virtual CPU and the pausing the execution of the first virtual CPU comprises the executing the second virtual CPU and the pausing the execution of the first virtual CPU in virtual CPU preemption manner subsequent to the request of either the first protected service or the second protected service during the execution of the first application executed based on the general guest operating system of the first virtual machine.

9. The method of claim 8, wherein the hypervisor allocates the first virtual CPU and the second virtual CPU to the second virtual machine, and the method further comprises:
a scheduler of the protected guest operating system of the second virtual machine scheduling a task for the first protected service to be performed using the first virtual CPU and a task for the second protected service to be performed using the second virtual CPU.

10. The method of claim 9, wherein the hypervisor allocates a first physical CPU of the computing device to the first virtual CPU and a second physical CPU of the computing device to the second virtual CPU.

11. The method of claim 8, wherein the executing the second virtual CPU and the pausing the execution of the first virtual CPU comprises creating a transaction and providing the transaction to a system interconnector, the transaction comprising an address space identifier (ASID) corresponding to either the first protected service or the second protected service.

12. The method of claim 11, wherein the transaction includes a unique identifier of the second virtual machine.

13. The method of claim 11, wherein the providing the transaction to the system interconnector comprises mapping an address space of a physical memory corresponding to the transaction by using the address space identifier based on a memory table for each address space identifier associated with a memory management unit of a first stage.

14. The method of claim 13, wherein the memory management unit of the first stage is hardware provided in the computing device, and
the protected guest operating system comprises a memory management unit driver that controls the memory management unit of the first stage.

15. A method for controlling access to a memory address space of a DMA master IP, the method being performed by a computing device that supports a non-trusted execution environment, a trusted execution environment, and a protected execution environment,
wherein the non-trusted execution environment and the protected execution environment operate within a central processing unit (CPU) in a first state, and the trusted execution environment operates within a CPU in a second state, which is separate from the first state,
and wherein the method comprises:
booting a hypervisor installed in the computing device in response to power-on of the computing device;
provisioning a first virtual machine that provides the non-trusted execution environment and a second virtual machine that provides the protected execution environment, by using the hypervisor;
executing a first protected service as a first instance and executing a second protected service, distinct from the first protected service, as a second instance, by a protected guest operating system of the second virtual machine; and
performing memory access control of a memory access transaction output from the DMA master IP, the memory access control being performed through a memory management unit of a first stage and a memory management unit of a second stage, the memory management unit of the second stage comprising a memory table for each virtual machine identifier (VMID),
wherein the performing memory access control comprises:
specifying an accessible address space of the memory access transaction among memory areas of the second virtual machine by the memory management unit of the first stage based on at least one of a port, a stream ID or an address space identifier (ASID) of the memory access transaction, and
wherein the hypervisor in the computing device is a type-1 hypervisor installed directly in the computing device without an operating system.

16. The method of claim 15, wherein the executing the first protected service and the second protected service comprises:
providing an address space ID (ASID) tag driver of the hypervisor with an ASID tag request of the first protected service for the DMA master IP, and
providing a virtual machine ID (VMID) tag driver of the hypervisor with a VMID tag request of the second virtual machine for the DMA master IP by the first protected service during execution of the first protected service, and
wherein the specifying an accessible address space of the memory access transaction comprises:
specifying the accessible address space of the memory access transaction as an address area of the first protected service based on the ASID of the first protected service being included in the memory access transaction.

17. The method of claim 15, wherein the specifying the accessible address space of the memory access transaction comprises specifying the accessible address space of the memory access transaction as the address space of the first protected service based on the ASID not being included in the memory access transaction and the port of the memory access transaction corresponding to the first protected service.

18. The method of claim 17, wherein the specifying the accessible address space of the memory access transaction comprises specifying the accessible address space of the memory access transaction as the address space of the first protected service based on the ASID not being included in the memory access transaction and the port and the stream ID of the memory access transaction corresponding to the first protected service.

19. A method for controlling access to a memory address space of a DMA master IP, the method being performed by a computing device that supports a non-trusted execution environment, a trusted execution environment, and a protected execution environment,
wherein the non-trusted execution environment and the protected execution environment operate within a central processing unit (CPU) in a first state, and wherein the trusted execution environment operates within a CPU in a second state, which is separate from the first state, and
wherein the method comprises:
booting a hypervisor installed in the computing device in response to power-on of the computing device;
provisioning a first virtual machine that provides the non-trusted execution environment and a second virtual machine that provides the protected execution environment, by using the hypervisor;
executing a first protected service as a first instance and executing a second protected service, distinct from the first protected service, as a second instance, by a protected guest operating system of the second virtual machine;
assigning a virtual machine identifier (VMID) of a protected partition virtual machine (ppVM) for the second protected service by the hypervisor;
providing a virtual machine ID (VMID) tag driver of the hypervisor with a VMID tag request for DMA IP by the second protected service, the VMID tag request being for tagging the VMID of the ppVM; and
performing memory access control to an address space of the second protected service for a memory access transaction output from the DMA master IP through a memory management unit having a memory table for each VMID,
wherein the hypervisor in the computing device is a type-1 hypervisor installed directly in the computing device without an operating system.

20. The method of claim 19, wherein the assigning the VMID of the ppVM comprises:
creating the ppVM having only a memory partition indicating the address space of the second protected service; and
assigning the VMID of the ppVM to the second protected service.
